(19) United States
(12) Patent Application Publication
(10) Pub. No.: US 2002/0095457 A1
(43) Pub. Date: Jul. 18, 2002

(54) System and methods for sharing and viewing supply chain information

(75) Inventors: Deep Sharma, Downingtown, PA (US); Michael Mulqueen, West Chester, PA (US); Sundar Arunapuram, West Chester, PA (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Manugistics, Inc., Rockville, MD

(21) Appl. No.: 09/984,350

(22) Filed: Oct. 29, 2001

Related U.S. Application Data
(60) Provisional application No. 60/243,400, filed on Oct. 27, 2000.

(51) Int. Cl. G06F 15/16; G06F 17/60

(52) U.S. Cl. 709/203; 705/7

(57) ABSTRACT

The invention provides a system and methods for retrieving selected supply chain data from various supply chain information databases and presenting the selected data to a user for viewing. The invention allows sharing of supply chain information by receiving a data request from a user, filtering the data request, issuing a data request to an application that retrieves the data from at least one associated database, organizing the data retrieved by the application, and sending the organized data for display to the user that originated the request. The invention also provides a two-tier security system whereby the user's data access is restricted to the type of data that it is authorized to view as well as confining the user's access to predetermined fields within that data type. Finally, the invention provides a system and methods for organizing the data presented to the user in a logical and efficient manner that is responsive to the user's preferences.

### CROSS REFERENCE TO RELATED APPLICATIONS

This application claims priority from U.S. Provisional Patent Application Serial No. 60/243,400, filed Oct. 27, 2000, the disclosure of which is hereby incorporated by reference in its entirety.

### FIELD OF THE INVENTION

The present invention relates to a system and methods for supply chain management and control. More specifically, the invention relates to a system for viewing desired supply chain data across an entire supply chain.

### BACKGROUND OF THE INVENTION

Within the modem economy, the supply of goods and products is increasingly critical to the success of any organization. Businesses that operate on the Internet, for example, must typically transport goods to every customer who orders their products. For these businesses, product supply is not merely a simple business function that must be managed; rather, it is a strategic function that influences every aspect of their business from revenue generation to customer satisfaction. Adding to the difficulty of managing supply chain factors is the complex relationship between trading partners, which can sometimes be adversarial. A supply chain is typically a reticulated network of people and organizations interacting dynamically to supply, and sell, their products and services. A trading partner is a supplier, customer, subsidiary, or any other organization or persons that participates in the supply chain or network.

Given the immense importance of supply chain factors to the overall health of an organization, organizations have understandably attempted to develop a variety of techniques for sharing information relevant to their supply chain functions. The ability to respond quickly and efficiently to problems in supply chain management is necessary for an organization's survival in today's dynamic global marketplace. Real-time access to information relevant to supply chain management is therefore critical. Unfortunately, it is often very difficult for supply chain trading partners to obtain relevant and accurate information on a timely basis. The inability of trading participants to share information is exacerbated by the fact that businesses often use different management systems. As a result, relevant information is often unavailable simply because there is no system for sharing information among supply chain participants.

Developers have developed customized applications for monitoring various supply chain factors. These customized applications are capable of monitoring various supply chain factors and gathering data relevant to these factors, e.g., inventory status. While these customized applications collect supply chain data, they do not provide a uniform mechanism for presenting the monitored data to supply chain partners in real-time and in a format that allows real-time viewing of data from different monitoring applications. Thus, in order for the supply-chain monitoring applications to be most beneficial, there is a need for a mechanism by which data from the various monitoring applications may be viewed in real-time in a useful, readable fashion. Further, there is a need for a system and methods that provide a uniform interface for viewing supply chain information in real-time from a variety of sources. Furthermore, a need exists to allow supply chain participants to view supply chain data from different data acquisition applications in a logical format defined by their data preferences.

Thus, a system and methods that overcome the deficiencies in the current supply chain information sharing methodology is desirable. In particular, a web-based application that is designed to facilitate the dissemination of information on an as-requested basis to any authorized supply chain partner is highly desirable. Such system and methods will dramatically improve supply chain efficiency, allowing for better-on time delivery, increased response time, shorter fulfillment time, less inventory investment, higher productivity per employee, improvement in cash-to-cash cycle time and fewer investments in material acquisition.

### SUMMARY OF THE INVENTION

In order to overcome the deficiencies in the existing supply chain information dissemination described above, the invention provides a system and methods for providing supply chain partners with access to supply chain data across multiple monitoring applications. The invention also provides a security feature that ensures that only authorized partners have access to information that they are authorized to view.

The system according to the invention may be accessible over any network, including the Internet and provides an open architecture enabling any business or organization to seamlessly integrate with its functionality

The invention provides a system and methods for sharing supply chain information in real-time.

The invention also provides a uniform interface allowing supply chain partners to view supply chain information in real-time.

The invention also provides a system and methods for filtering supply chain information to ensure that only organizations authorized to view the data are permitted to do so.

In order to carry out these and other functionalities, the invention provides methods for viewing supply chain information that includes the steps of generating a request for supply chain information, transmitting the request for supply chain information to a central supply chain management server, processing the received request for supply chain information, and sending the requested supply chain information to a user generating the request.

The invention further provides a system for a user interface for generating a request for supply chain information and an administrative server for receiving and processing the request for supply chain information.

### BRIEF DESCRIPTION OF THE DRAWINGS

FIG. 1 illustrates a block diagram of the supply chain information-sharing system in accordance with an embodiment of the invention;

FIG. 2 illustrates a block diagram of the command flow for the supply chain information system in accordance with an embodiment of the invention;

FIG. 3 illustrates a block diagram of the system architecture for the supply chain information-sharing system in accordance with an embodiment of the invention;

FIG. 4 is a flowchart illustrating the process for viewing shared supply chain information in accordance with an embodiment of the invention; and

FIGS. 5a-c illustrate examples of freight movement data fields retrieved from a transportation database query in accordance with an embodiment of the invention.

### DETAILED DESCRIPTION OF THE PREFERRED EMBODIMENTS

The invention disclosed herein incorporates by reference the subject matter of copending and commonly assigned U.S. Non-Provisional Patent Applications, entitled “System and Method for Optimizing Resource Plans,” Shekar et al., Attorney Docket No. 82001-0198, filed Oct. 29, 2001; “System and Method for Supply Chain Management, Including Collaboration,” Zarefoss et al., Attorney Docket No. 82001-0189, filed Oct. 1, 2001; “System and Method for Inventor and Capacity Available Management,” Greamo et al., Attorney Docket No. 82001-0190, filed Oct. 29, 2001; and “Transportation Planning, Execution, and Freight Payment Managers and Related Methods,” Rajagopal, Attorney Docket No. 82001-0123, filed Jun. 18, 2001, application Ser. No. 09/882257. The invention disclosed herein also incorporates by reference the subject matter of co-pending and commonly assigned U.S. Provisional Patent Application, entitled “System and Method for Enabling Collaborative Procurement of Products in a Supply Chain,” Rioux, filed Dec. 14, 2000, application Ser. No. 60/255,156.

The invention facilitates the dissemination of information, on an as-requested basis, to any interested and authorized supply chain participant by seamlessly retrieving the information from various applications, and their associated databases. After retrieving the requested information, the system and methods disclosed herein then present the information in a logical, intuitive and valuable manner, allowing the enterprise that requested the information to make any necessary decisions in real-time to correct or prevent supply chain problems.

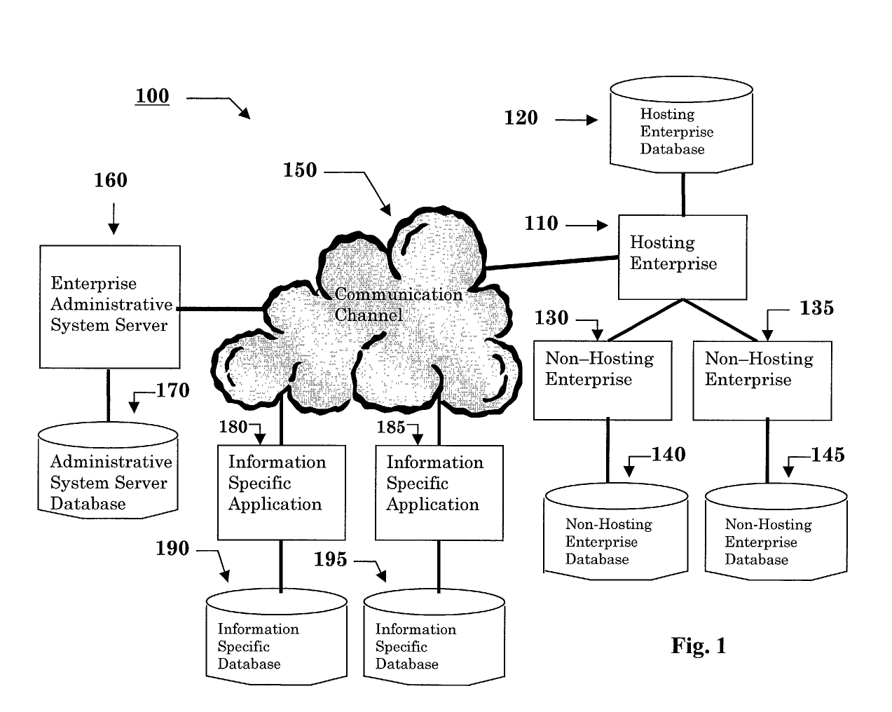

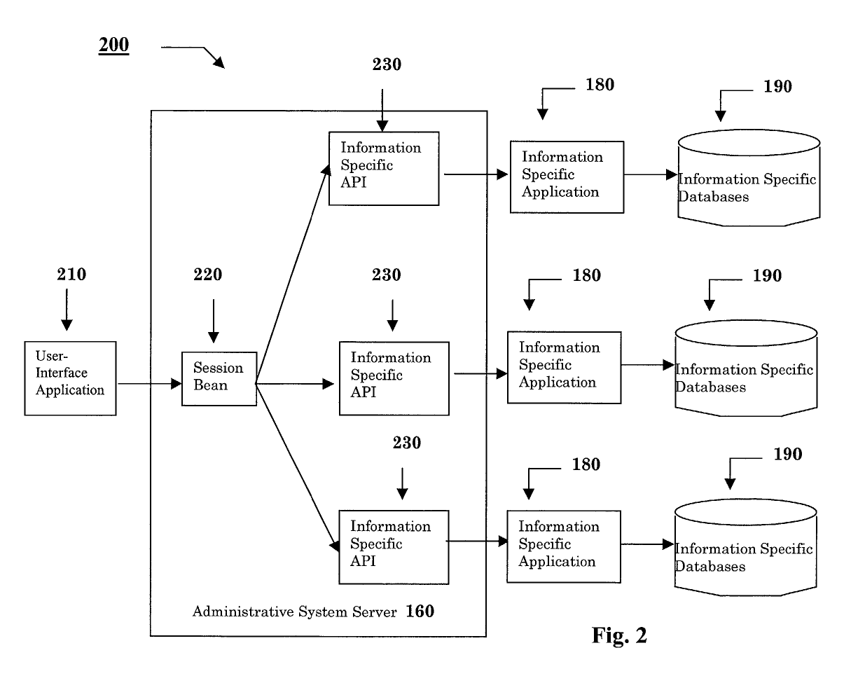

FIG. 1 shows a supply chain information-sharing system 100 in accordance with one embodiment of the invention. In FIG. 1, the system 100 includes a hosting enterprise 110 in communication with an enterprise administrative system server 160 via a communication channel 150. The hosting enterprise 110 may also be in communication with an associated hosting enterprise database 120 that stores data related to the supply chain community that it hosts. Similarly, the enterprise administrative system server 160 may likewise be in communication with an associated enterprise administrative system server database 170 that stores data related to the administration of the system 100. The system 100 may also include at least one non-hosting enterprise 130 and/or 135, in communication with the hosting enterprise 110, which may be in communication with an associated non-hosting enterprise database 140 and/or 145, respectively, that stores configuration data. Additionally, the system 100 includes at least one information specific application 180 and/or 185 in communication with the enterprise administrative system server 160, via the communication channel 150. Each information specific application 180 and/or 185, respectively, may be in communication with an associated information specific database 190 and/or 195, respectively, that stores related supply chain information.

The communication channel 150 may be any medium or network through which information may be exchanged, including, but not limited to, the Internet, intranet, Plain Old Telephone System (“POTS”), satellite links, terrestrial links, and wireless devices. The hosting enterprise 110 and/or the non-hosting enterprises 130 may be supply chain trading partners participating in either a 1-to-1, a 1-to-many, or a many-to-many capacity with other supply chain entities. The hosting enterprise is a trading partner that hosts a trading community. A trading community may be a collection or group of supply chain partners. The hosting enterprise 110 may be a conduit for either a single organization or separate entities to access the enterprise administrative system server 160.

As such, the hosting enterprise 110 is either the controller of the communication channel 130, and therefore sponsors and manages the trading community, or is a third party provider that sponsors the community on behalf of its trading partners. Sponsoring a trading community includes management and control of access to the enterprise administrative system server 160, via the communication channel 150, for the entire community. Thus, the hosting enterprise 110 is the enterprise represented in the enterprise administrative system server 160. The non-hosting enterprises 130 and 135 are in communication with the hosting enterprise 110 and therefore access the enterprise administrative system server 110 via the hosting enterprise 110. The hosting enterprise 110 therefore may be considered to act as a parent to the associated non-hosting enterprises 130 and/or 135 and, as such, has special privileges. For example, the hosting enterprise 110 has the ability to administer system objects, such as configuration tables, in the administrative system server 160 on behalf of the non-hosting enterprises 130 and can select the name to be associated with these objects.

Data related to the administration of the system 100, such as the application program interfaces (APIs) that are responsible for issuing commands for data, may be stored in the enterprise system administrative database 170, which is in communication with the administrative system server 160. Similarly, data related to the activities of the hosting enterprise 110 may be stored in the hosting enterprise database 120, which is in communication with the hosting enterprise 110. Additionally, data related to the activities of a non-hosting enterprise 130 may be stored in the non-hosting enterprise database 140, which is in communication with the non-hosting enterprise 130. The enterprise administrative system server 160 is also in communication, via the communication channel 150, with one or more information-specific applications 180. These applications, either pre-defined or custom created, may be written for a particular application and are responsible for retrieving data from the associated information specific databases 190. The information specific database 190 is thusly in communication with the information specific application 180 that it serves.

In operation, the hosting enterprise 110 may initiate a supply chain query by sending a request for a specific type of data to the enterprise administrative system server 160. This request may be on its own behalf or on the behalf of a non-hosting enterprise 130 that is a member of the trading community that is served by the hosting enterprise 110. The administrative system server 160 then determines whether the hosting enterprise 110 or non-hosting enterprise 130 that issued the data request. i.e. the user, has the appropriate role for the data type(s) being requested. Accordingly, the enterprise administrative system server 160 will issue a data request to the appropriate information specific application 190 only if the user has the role required for the specific data type.

Roles are a security mechanism by which the enterprise administrative system server 160 is able to restrict access to particular data types to those enterprises that have permission to view them. For example, a customer service representative may have the authority, or role, to see both order commitment (“commitment”) and order transportation (“transportation”) data, while the end customer, who is associated with a different role, may be restricted to viewing only transportation data. Role restrictions not only provide an increase measure of security, but also reduce query time by limiting the amount of data for which the enterprise administrative system server 160 will need to issue requests.

After receiving a data request from the enterprise administrative system server 160, the information specific application 180 executes the request by retrieving the requested data from its associated information specific databases 190 and sending the data to the enterprise administrative system server 160 for filtering. An information specific application 180 is an application that is responsible for interrogating, or querying, its associated information specific database 190 and retrieving a specific data type from the database 190. For example, if a user requests transportation information, the administrative system server 160 will call a transportation application that is responsible for retrieving the requested data from transportation databases. Filtering provides an additional layer of security to the system 100 by restricting the information within an approved data type that the hosting enterprise's 110 users will be able to view That is, notwithstanding that a hosting enterprise 110 is granted rights to view a data type associated with an information specific application 180, the enterprise might be restricted from viewing specific fields within that data type. For example, a hosting enterprise 110 may wish to restrict an associated non-hosting enterprise to only have access to purchase orders that are in a certain status, or that originate from a particular supplier. The ability to restrict data based on the user's permission level is imperative to ensure that accessed data is secure.

Therefore, before submitting the retrieved data to the hosting enterprise 110, the administrative system server 160 determines for what data the user, i.e., either the hosting enterprise 110 or the associated non-hosting enterprise 130, is authorized to view. The enterprise administrative system server 160 removes the data fields that the user is not entitled to view and logically arranges the data depending on the preferences of the user's data request. The enterprise administrative system server 160 then sends the data to the hosting enterprise 110, which then either views the data itself on a local platform, such as an HTML browser or other viewing application, or sends it to the non-hosting enterprise 130 that originated the data request to view.

FIG. 2 illustrates a command logic flow diagram for the supply chain information sharing system 100 in accordance with an embodiment of the present invention. Specifically, FIG. 2 shows a user-interface 210, which may reside on the hosting enterprise 110, shown in FIG. 1, in communication with a session bean 220. The session bean may reside on the administrative system server 160, shown in FIG. 1, and is in communication with one or more information specific APIs 230, which may also reside on the administrative system server 160. The information specific API 230 is in communication with an information specific application 180, shown in FIG. 1. The information specific application 180 in communication with, and is responsible for querying, its associated information specific databases 190, shown in FIG. 1.

In operation, a user using the user-interface 210 may send a data request to a session bean 220, residing on the administrative system server 160. The session bean issues a data request to an information specific application programming interface (“API”) 230 and constructs a data filter based on the configuration of the user that issued the request. Depending on the data request issued from the hosting enterprise 110, the data may reside on one or more information specific databases 190, and may be as varied as purchase orders, customer orders, transportation orders, and/or transportation movements. In accordance with one embodiment of the invention, each information specific application 180 that is in communication with, or plugged into, the administrative system server 160 should have a session bean 220 that can perform the required queries. The configuration of the hosting enterprise 110, shown in FIG. 1, may also determine what information the user that issued the data request is authorized to view.

The stateless session bean 220 that receives the data request uses the hosting enterprise's 110 configuration to construct a filter for the data returned from each information specific API 230 that it calls. In this manner, the session bean 220 is able to remove data that the user is not authorized to view. Thus, in one embodiment of the invention, the information specific API 230 performs only shallow queries to retrieve only the information required for the business entity or item being queried, in order to optimize querying performance. Furthermore, in accordance with one embodiment of the invention, the filtering function enhances the security of the system by allowing the administrative system server 160, shown in FIG. 1, to limit or control the ability of the user to: view purchase order data, view archived purchase order data, view purchase line item data, view archived purchase line item data, view delivery order data, view archived delivery order data, view freight movement data, view freight movement history data, view customer order data, view customer line item data, view inventory data, view inventory status data, drill down, or scan, to view audit information data, query for current inventory data, query for available to promise data, and query for capable to promise data. Additionally, in accordance with one embodiment of the invention, the filtering function allows the user to export search results as a comma-separated file.

Each information specific API 230 that is called by the session bean 220 calls the appropriate information specific application 180 to retrieve the requested information from an associated information specific database 190. After receiving the requested information from the information specific application 180, the information specific API 230 sends the data to the session bean 220 for further processing. For example, if the session bean 220 executes a request for transportation specific data, the session bean 220 will call a transportation API, which in turn will issue the request to the transportation application which will search for transportation-specific data on its transportation databases.

After receiving the requested data from the information specific API 230, the stateless session bean 220 collects the information and presents it to the hosting enterprise 110, shown in FIG. 1, in a format consistent with the user's customized configuration settings. That is, the session bean 220 collects the information returned by the information specific APIs 230 and presents it to the user based on the user's configuration settings.

In addition to determining the number of product specific APIs 230 that are called by the session bean 220, the user's configuration settings determine the order in which the different APIs are invoked. The order in which the APIs are invoked depends on the filter constructed by the session bean 220. For example, if the user issues a data request to by transportation order ID, the session bean 220 will first call the transportation API to retrieve transportation order and freight movement information before issuing another request to a different information specific API 230. If the user also desires order procurement (“procurement”) information corresponding to this transportation order ID, the session bean 220 will pass the delivery order ID corresponding to the transportation ID to the procurement API. The procurement API then issues the request to retrieve the delivery order and line item information for the transportation order ID. The session bean 220 filters and processes the information from the different information specific APIs 230 before presenting it to the host enterprise 110 that issued the request. The filtering process will be discussed in greater detail below.

In one embodiment of the invention, the presentation of the data may be tied to an entity/application pair, and thus each query for data must have a primary information specific application 180, precluding users from querying on cross information specific applications 180 simultaneously. For example, a user might want transportation freight information concerning a product ID or a particular carrier shipping the freight. However, the user will not be able to query on a transportation freight movement and a procurement purchase order simultaneously because the returned data is tied to a specific primary data type and data field combination. That is, based on the business entity or item selected for querying, a primary information specific application 180, shown in FIG. 1, is identified and the query is directed towards that information specific application 180. Thus, the administrative system administrative server 160 may initiate a data flow to a particular information specific application 180. After the primary information specific application 180 has processed the initial query, further queries may be associated with that primary information specific application 180 or a different information specific application 180. Although the initial or primary data query may not span across multiple information specific applications 180, the results of the data query may. For example, a data query on a freight movement might return both transportation information as well as procurement delivery line information.

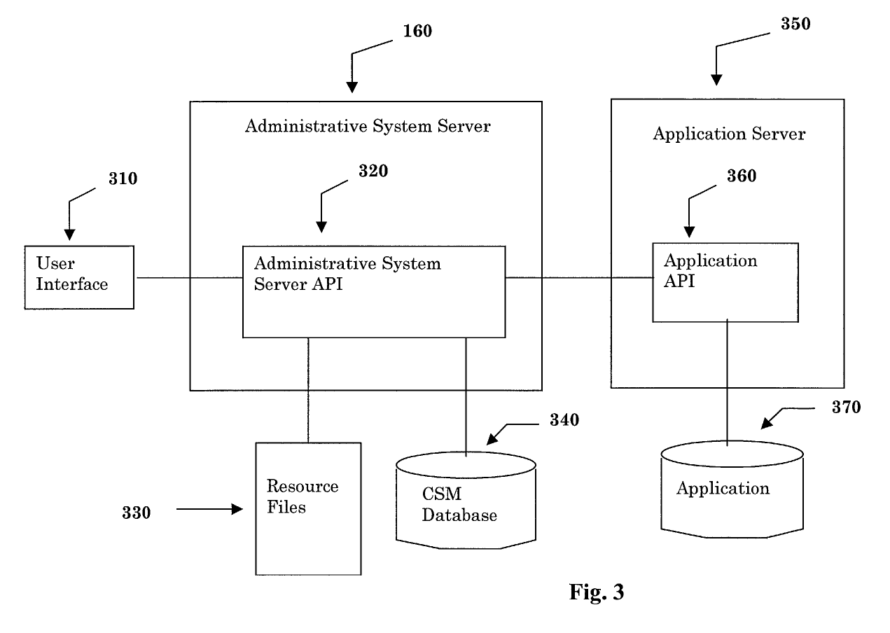

FIG. 3 illustrates a system architecture for the supply chain information sharing system 100 in accordance with an embodiment of the present invention. Specifically, FIG. 3 shows a user-interface 310 in communication with an administrative system server API 320 that resides on the administrative system server 160, shown in FIG. 1. The user-interface 310 may reside on the hosting enterprise 110 or the non-hosting enterprise 130, both shown in FIG. 1, and may be a browser, a Java® server page (JSP), a graphical user interface (GUI), or any such interface that allows a user to enter parameter values. FIG. 3 further shows the administrative system server API 320 in communication with resource files 330, a common security mode (CSM) database 340, and an application API 360 that resides on an application server 350. The application API 360, is also shown in communication with an associated application 370.

In operation, the user, through the user-interface 310, selects a business entity or item upon which to initiate a query. Every business entity or item is associated with a specific application that will both store and search for information pertaining to the entity or item. After receiving the query parameters from the user, the user-interface communicates both the query request and the query parameters to the administrative system server API 320.

Information concerning the application APIs 360 may be stored in the resource files 330. The resource files 330 may be an extensible markup language (XML) file, a hyper-text mark-up language (HTML) file, or any file type that may be communicated from one server to another. The resource files 330 also define various other properties including, but not limited to, the columns of data that may be sorted, the columns that need to be summed, and the columns that are hyperlinks to other entities. These properties are used by the user interface 310 to display the queried business entities or items on a screen.

At start-up, the administrative system server API 320 retrieves the API information from the resource files 330. Each business entity or item is associated with one resource file 330, which associates the business entity with at least one application 370. After the administrative system server API 320 correlates the business entity or item being queried with the appropriate application, the administrative system server API 320 looks up the application name, application server host name, protocol, and port number in the CSM database 340. This may be necessary because application APIs 360 may be registered on different application servers 350.

The administrative system server 160 uses the application information from the resource file 330 to create an instance of the application API 360. An instance is a piece of information of configuration, management, or statistical information pertaining to the application API 360. After retrieving the pertinent information and creating an instance for the application API 360, the administrative system server API 320 calls the appropriate application API 360 to initiate the query on the business entity or item. This call may be made using a Java® routine to keep the software code both generic and portable.

In calling the appropriate application API 360, the administrative system server API 320 passes the user-defined query information to the application API 360 in the form required by the application API 360. For example, if the administrative system server API 320 calls the transportation API, the user-defined information will be passed to the transportation API in the form of a transportation filter object. After receiving the user-defined information from the administrative system server API 320, the application API 360 sends the query request to the appropriate application 370 to search for relevant information pertaining to the business entity or item for which the user has requested the information.

The application API 360 returns the search results from the application 370 to the administrative system server API 320 in any number of known formats, such as a Java® collection object or a Java® object. The administrative system server API 320 then processes the search result information and converts this information into generic result objects. The administrative system server API 320, or the administrative system server 160, uses the information in the resource files 330 to determine the method name and signatures that are used to generate the generic result objects. After the search information has been converted into generic result objects, the administrative system server API 320 passes the generic objects to the user interface 310 to be displayed on the user's screen. According to one embodiment of the invention, the generic objects may be passed to the user interface as a Java object collection or as a single Java object.

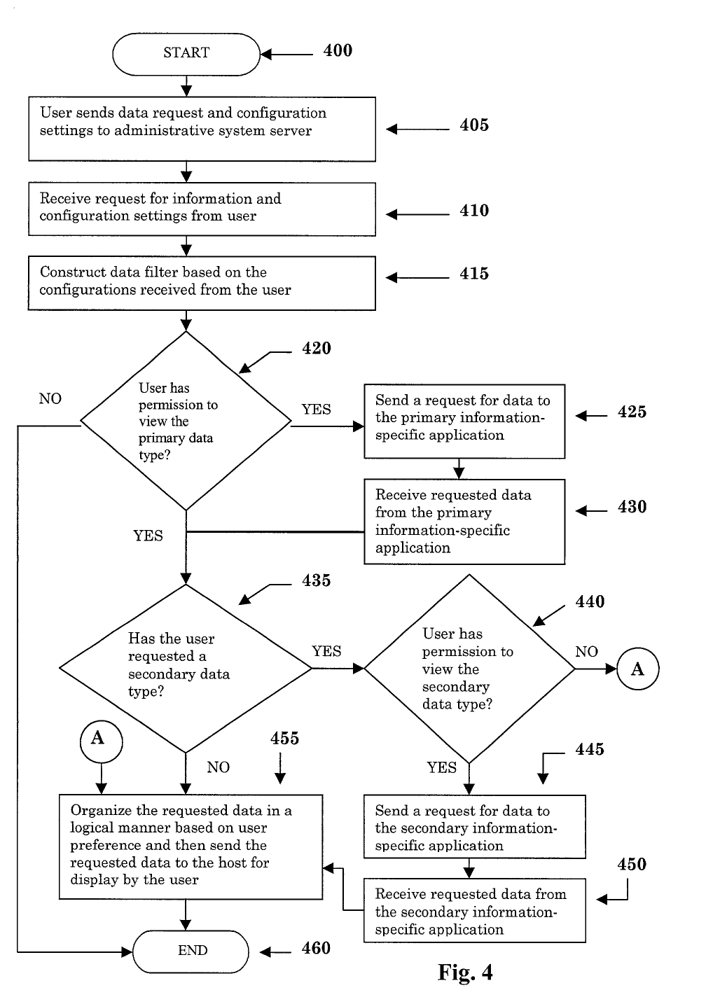

FIG. 4 shows a flowchart illustrating the process for presenting supply chain data from multiple applications to supply chain participants. The process begins at step 400. In step 405, a user generates and sends a data request and configuration settings, through a host, to a centralized administrative server. The user may be a member of a non-hosting enterprise or part of the hosting enterprise. In either instance, the user's data request may be forwarded to the administrative system server via a common host, i.e., the hosting enterprise 110. In step 410, the administrative system server may receive configuration settings and/or a data request from the host that is hosting the user that issued the data request.

The process proceeds to step 415. In step 415, the administrative system server, after receiving the user's data request, constructs a data filter based on the user's roles and configuration settings. The process then moves to step 420. In step 420, the administrative system server determines whether the user has the appropriate role permission to view the requested primary data type. If the user has the appropriate role permission to view the requested data type, the process moves to step 425, otherwise the process moves to step 460, and ends. In step 425, the administrative system server sends a request for the specific data to the application monitoring and/or storing the particular data requested by the user. The process then moves to step 430. In step 430, the administrative system server receives the requested data from the selected application. The process then moves to step 435.

In step 435, the administrative system server determines whether the user issued a secondary data request. If the user has issued a secondary data request, the process moves to step 440, otherwise, the process moves to step 455. In step 440, the administrative system server determines whether the user has the appropriate role permission to view the requested secondary data type. If the user has the appropriate role permission to view the secondary data type, the process moves to step 445, otherwise the process moves to step 455. In step 445, the administrative system server sends a request for the specific data to an application monitoring and/or storing the particular data requested by the user. In step 450, the administrative system server receives the requested data from the selected application. The process then moves to step 455.

In step 455, the centralized administrative system server first sorts the data by user preference and then organizes the data in a logical manner based on that preference. For example, the secondary data may be sorted based on data fields contained in the primary information retrieved by the information specific application. The centralized administrative system server then sends the data, for which the user has the appropriate role and permission to view, to the user for display. The process ends at step 460.

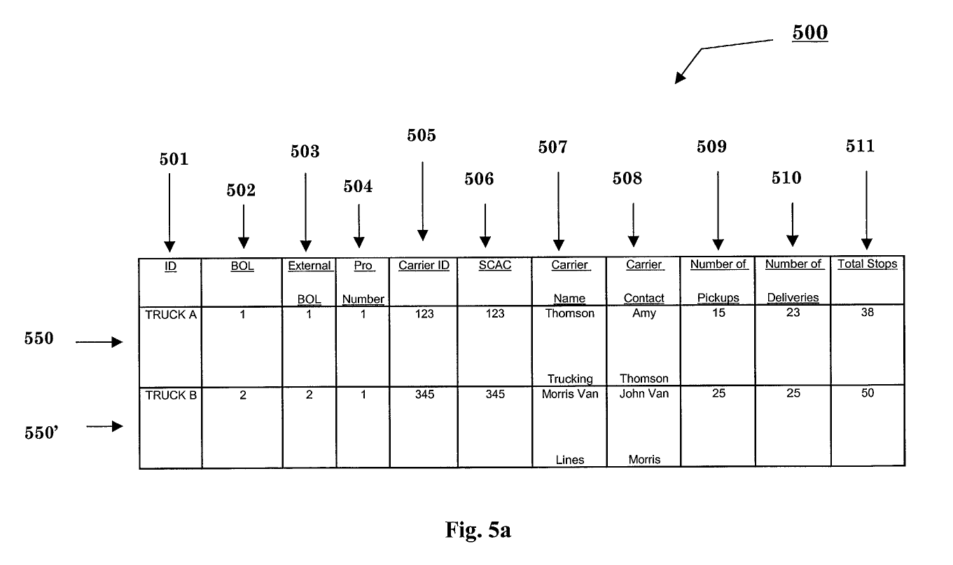

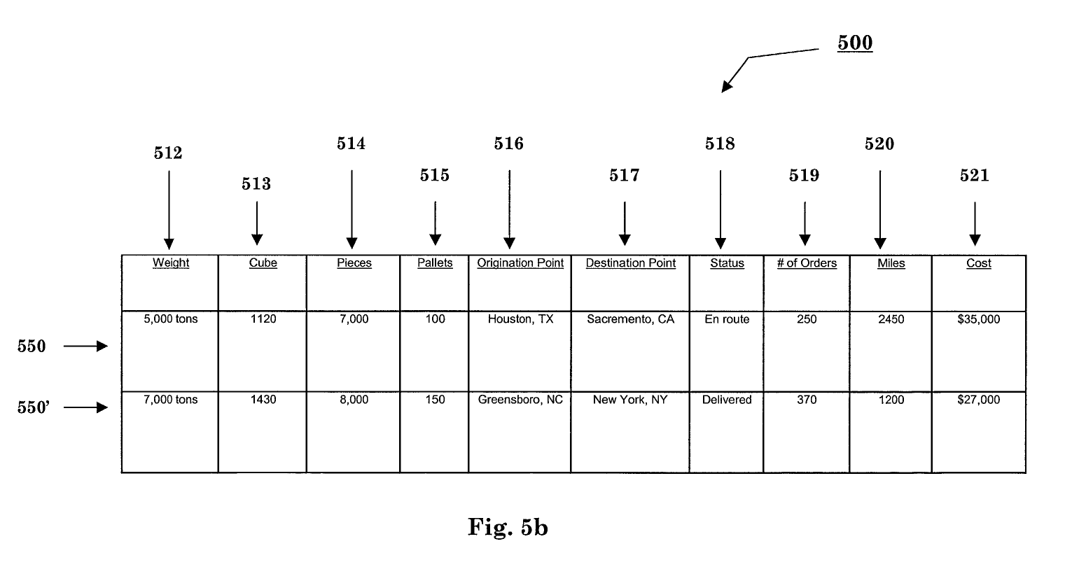

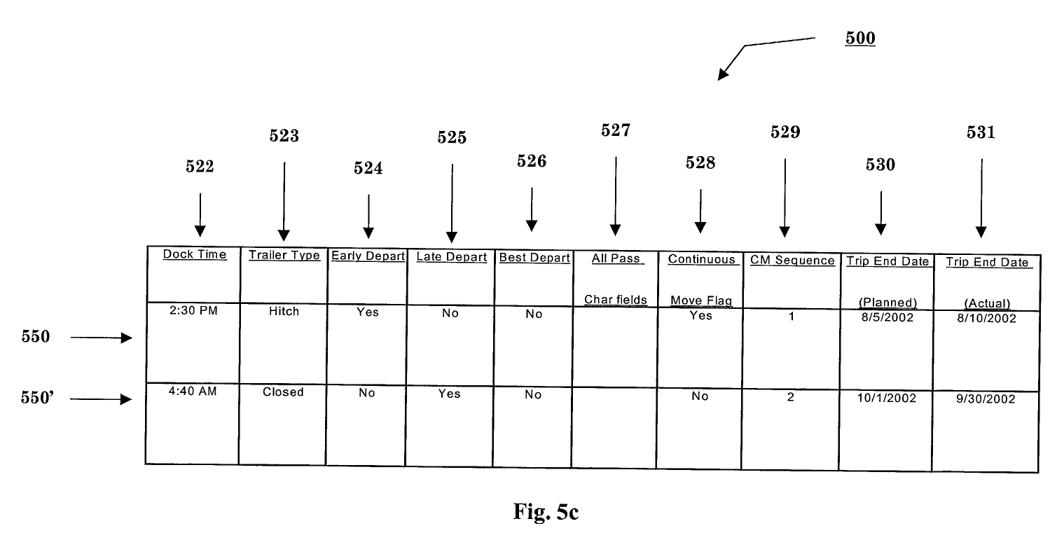

FIGS. 5a-c show, for illustrative purposes only, examples of data fields, for a specific data type, that may be viewed by users for specific applications in accordance with an embodiment of the invention. These figures show various data fields that may be displayed depending upon the combination of data type and specific field selected by the user. That is, the user selects a data type related to a specific application and then has the option to select the specific data fields within that data type that it wishes to view. The user does not need to review each data field that is shown for a particular data type, but may instead, if the user wishes, select only those fields that are relevant to the particular data query.

The returned data fields may then be linked, sorted, and displayed based on any one particular data field. It should be noted, however, that irrespective of the user's selection, the enterprise administrative system server 160, shown in FIG. 1, has the ability to restrict the user from viewing any data element that may be unnecessary or might cause a breach in security. Of course, other applications may be developed in accordance with embodiments of the invention to monitor and/or store data types and data fields that are not so enumerated and implemented. The following figures are therefore for illustrative purposes only.

Specifically, FIGS. 5a-c show, for illustrative purposes, the data fields that are available to a user to view when the user has selected an application that provides freight movement data from within the transportation database A sample query for freight movement data may return one or more freight movement data fields that match the query. The freight movement data fields therefore contain information relevant to a particular freight shipment. FIGS. 5a-c also show, for illustrative purposes, records 550 and 550′, which contain example values for each of the freight movement data fields. If the role of the user is of the appropriate permission level, the user may also view audit trail data fields associated with the queried freight movement.

FIG. 5a shows an ID data field 501, a BOL data field 502, an external BOL data field 503, a pro number data field 504, a carrier ID data field 505, a SCAC data field 506, a carrier name data field 507, a carrier contact data field 508, a number of pickups data field 509, number of deliveries data field 510, and a total stops data field 511. The ID data field 501 identifies the freight movement data record. The BOL data field 502 identifies the specific bill of lading associated with the freight movement identified by the ID data field 501. The external BOL data field 503 is the bill of lading number used externally to identify the delivery. The pro number data field 504 contains a number identifying the specific freight delivery. The carrier ID data field 505 contains the ID number of the carrier responsible for shipping the freight and/or cargo. The SCAC data field 506 contains data pertinent to the identification of the freight carrier. The carrier name data field 507 contains the name of the carrier responsible for shipping the freight and/or cargo. The carrier contact data field 508 contains the name of the contact person at the aforementioned carrier. The number of pickups data field 509 contains the number of locations at which the carrier will stop to load freight and/or cargo. The number of deliveries data field 510 contains the number of locations at which the carrier will stop to unload freight and/or cargo. The total stops data field 511 contains the total stops that the carrier will make, either to load and/or unload freight. The user may select this data field to sort and view the data to assist the user in determining the total orders that comprise a particular trip. For example, the user can query on specific orders and view the individual line items of the order to sort by ID data field 501 to determine which orders were delivered on the queried trip.

FIG. 5b shows a weight data field 512, a cube data field 513, a pieces data field 514, a pallets data field 515, an origination data field 516, a destination data field 517, a status data field 518, a no. of orders data field 519, a miles data field 520 and a cost data field 521. The weight data field 512 contains the gross weight of the freight for a particular order. The cube data field 513 contains the cubic feet of carrier storage occupied by the freight. The pieces data field 514 contains the number of pieces associated with the queried ID number data field 501. The pallets data field 515 contains the number of pallets to be shipped. The origination point data field 516 contains the location of the origin for the freight shipment associated with the queried ID number data field 501. The destination point data field 517 contains the location of the destination for the freight shipment associated with the queried ID number data field 501. The status data field 518 contains the current status of the associated freight shipment. The no. of orders data field 519 contains the total number of orders serviced by the freight shipment associated with the queried ID number data field 501. The miles data field 520 contains the total number of miles traveled by the carrier shipping the associated freight. The cost data field 521 contains the total cost of the associated freight being shipped.

FIG. 5c shows a dock time data field 522, a trailer type data field 523, an early depart data field 524, a late depart data field 525, a best depart data field 526, an all pass char fields data field 527, a continuous move flag data field 528, a CM sequence data field 529, a trip end date (planned) data field 530, and a trip end date (actual) data field 531. The dock time data field 522 contains the docking time of the most recent stop that the carrier made to either load and/or unload associated freight. The trailer type data field 523 contains the type of hitch the carrier is utilizing to transport the associated freight. The early depart data field 524 contains a flag indicating whether the most recent departure of the carrier was before its scheduled departure time. The late depart data field 525 contains a flag indicating whether the most recent departure of the carrier was after its scheduled departure time. The best depart data field 526 contains a flag indicating whether the most recent departure of the carrier was within a specified interval of its scheduled departure time. The all pass char fields data field 527 is a reserved field. The continuous move flag data field 528 contains a flag indicating whether the freight transportation has been continuous. The continuous move sequence data field 529 contains the locations of the continuous move. The trip end date (planned) data field 530 contains the estimated completion date of the final freight delivery and/or pickup for the associated carrier. The trip end date (actual) data field 531 contains the actual completion date of the final freight delivery and/or pickup for the associated carrier.

The user may select any of the above mentioned data types and data fields for viewing and may sort the displayed data on the basis of the selected data fields. As described above, therefore, the data fields described herein are merely illustrative of numerous supply chain data fields that may be viewed in accordance with the invention.

It will be apparent to those skilled in the art that various modifications and variations may be made to the system and method of monitoring supply-chain management methodology without departing from the spirit or the scope of the invention. Thus, it is intended that the present invention cover the modifications and variations of this invention, provided that they come within the scope of any claims and their equivalents.

What is claimed is:

1. A method for viewing supply chain information from at least one supply chain information gathering application, comprising the steps of:
generating a request for supply chain information;
transmitting the request for supply chain information to a central supply chain management server;
processing the received request for supply chain information; and
sending the requested supply chain information to a user generating the request.

2. The method according to claim 1, wherein the step of generating a request includes selecting an information data type.

3. The method according to claim 2, further including the step of selecting at least one data field associated with the information data type.

4. The method according to claim 1, wherein the request includes a permission role associated with the user generating the request.

5. The method according to claim 4, wherein the permission role includes an authorization to view at least one data information type and at least one data field associated with the at least one data information type.

6. The method according to claim 4, wherein the processing step further includes:
filtering the request for supply chain information;
issuing a data retrieval order based upon the filtered request; and
receiving supply chain information based upon the issued data retrieval order.

7. The method according to claim 6, wherein the step of filtering the request includes determining, based upon the permission role, whether the user generating the request has a permission to view the requested supply chain information.

8. The method according to claim 6, wherein the data retrieval order is delivered to an information specific application.

9. A system for viewing supply chain information comprising:
a user interface for generating a request for supply chain information; and
an administrative server for receiving and processing the request for supply chain information.

10. The system according to claim 9, further including a centralized host.

11. The system according to claim 10 wherein the centralized host receives the request for supply chain information from the user interface, establishes a security configuration setting and sends the request and security configuration setting to the administrative server.

12. The system according to claim 9, further including an information specific application server.

13. The system according to claim 12, wherein the information specific application retrieves real-time supply chain information from at least one supply chain information database.

14. The system according to claim 9, wherein the request for supply chain information includes an information data type and a data field associated with the information data type.

15. The system according to claim 9, wherein the request includes a permission role.

16. The system according to claim 9, wherein the administrative server filters the request for supply chain information and issues a data retrieval order based upon the filtered request.

17. The system according to claim 16, wherein the issued data retrieval order is forwarded to an information specific application.

18. The system according to claim 9, wherein the administrative server includes:
a session bean; and
at least one information specific application program interface (API) communicatively coupled to the session bean, wherein the session bean receives the request for supply chain information and forwards the request to the API, and wherein the API calls an information application to retrieve the requested supply chain information.

19. A system for viewing supply chain information comprising:
generating means for generating a request for supply chain information; and
processing means for processing the request for supply chain information in order to retrieve the requested information.

20. A computer program product comprising a computer useable medium having computer readable code embodied thereon, the computer program product adapted to effect the steps comprising:
generating a request for supply chain information;
transmitting the request for supply chain information to a central supply chain management server;
processing the received request for supply chain information; and
sending the requested supply chain information to a user generating the request.
